(19) United States
(12) Patent Application Publication
(10) Pub. No.: US 2002/0194024 A1
(43) Pub. Date: Dec. 19, 2002

(54) Sabotage-proof and censorship-resistant personal electronic health file

(76) Inventor: Peter Kleinschmidt, Erlangen (DE)

Correspondence Address: YOUNG & THOMPSON, 745 SOUTH 23RD STREET 2ND FLOOR, ARLINGTON, VA, 22202

(21) Appl. No.: 10/154,828

(22) Filed: May 28, 2002

(30) Foreign Application Priority Data
May 29, 2001 (DE) 10126138.1

(51) Int. Cl. G06F 17/60

(52) U.S. Cl. 705/2

(57) ABSTRACT

A protected electronic health file for managing all the health-relevant data, including earlier diagnoses and treatments, of a patient in the form of data capsules on a number of decentralized servers of a network with an access code which can be released by the patient wherein, with every change or addition to a called-up data capsule, the old data capsules in the network are erased and a new access code is formed, under which the changed data capsule is re-stored again in the network.

The invention relates to a protected electronic health file for managing all the health-relevant data, including earlier diagnoses and treatments, of a patient in the form of data capsules on a number of decentralized servers of a network with an access code which can be released by the patient.

For the current treatment of a patient, it is extremely important for the person providing the treatment to be able to access data that is as complete as possible on the medical prehistory and patient-specific data, such as inoculations, allergies, intolerances etc. Here, completeness does not necessarily mean great detail, as explained later. On the other hand, these data are sensitive and must not get into the wrong hands. Apart from his memory, the doctor providing the treatment uses records in the form of a patient file and, when referring to another doctor, writes the most important data in a letter of referral. In practice, this presents a problem if the patient unexpectedly comes to a new doctor who, for reasons of time or other reasons, is not able to obtain the data of his colleagues. Moreover, these data are currently only restrictedly available to the patient, which in future could become a technical and legal problem if various health services are offered to the patient in a network.

There have previously already been numerous proposals and test installations which attempt to solve this problem by means of electronic communication equipment. They are based on the one hand on a patient file to be carried on the person, for example in the form of an electronic chip card, or on the other hand on a central network server, which each doctor is intended to be able to access. The straightforward card solution, which has already been discussed for years and has been introduced in some countries, involves the problems that the amount of data is only limited, that there is no availability of the data for tele services, that it can only be mechanically integrated into mobile computing and that there is no input possibility by keyboard/keypad, barcodes or electronic tags.

The central patient file referred to above is repeatedly put forward by network proponents. In this case, there is the difficulty on the one hand that, without harmonized data standards, such a patient file is not feasible in practice. Furthermore, however, there are also legal problems concerning data use, elaborate measures for security that nonetheless cannot ultimately be guaranteed and, as a result, the risk of loss of the data by sabotage and misuse of the data. The setting-up of private files with providers on the Internet, which has already been introduced on a trial basis, also cannot solve the problem referred to, since it is to be feared that data can be passed on unchecked, the privacy of the data is not guaranteed and the data are also in many cases incompatible with one another.

The lack of security even applies to health files of the type stated at the beginning in which the health-relevant data are stored in the form of data capsules on a number of decentralized servers of a network with an access code which can be released by the patient, as proposed for example in WO 01/18631 A1. If the access code gets into the wrong hands just once, continual misuse of the data cannot be prevented even in the case of this otherwise relatively secure system according to WO 01/18631 A1.

The invention is therefore based on the object of providing a protected electronic health file which is sabotage-proof and censorship-resistant and comprises increased security against the data being passed on without authorization or used without authorization.

To achieve this object, it is provided according to the invention that, with every change or addition to a called-up data capsule, the old data capsules in the network are erased and a new access code is formed, under which the changed data capsule is re-stored again in the network.

By this automatic changing of the access code when there is a change or addition to the data capsule, an unauthorized person who, for whatever reason, has once obtained the access code—for example with the authorization to view certain data once—does admittedly have the possibility of repeatedly viewing precisely these data, as long as the data capsule has not been changed. However, with every change of the data capsule, a change of the access code inevitably takes place, with storage of the changed data capsules under this new access code and at the same time erasure of the old data capsules. Consequently, even access to these old data is only possible to a very restricted extent for an unauthorized person in possession of the old access code, since all these data are erased when there is the first change to the data capsules.

The access code, which may be formed from personal data and memory data in the manner of a hash key, is intended in a refinement of the invention to contain a specially protected change authorization, by means of which the automatic erasure of the old data capsules is brought about. This can achieve the effect that the authorized person grants third parties subordinate access authorization, in which the access code does not contain change authorization, so that, although this third party can call up and view a data capsule, it cannot change it.

In a further refinement, it may also be provided in this case that viewing the data from a data capsule via a hereby postulated log file, which logs every access with a time stamp, already represents a change, which brings about an automatic change of the access code. However, this can only be expedient when the data are viewed by an authorized person with simultaneous change authorization, since otherwise the permitted viewing of the data by a third party by means of the erasure of the old data capsules and the storage of the new data capsules with changed access codes would make these data capsules no longer locatable even for the actual owner.

The erasure of the data capsules and the subsequent re-writing provides better utilization of the resources of a freenet and increases the redundancy of the data capsules stored in the freenet, since over a lengthy time there is the risk in a freenet of some of the peers involved detaching themselves from this network and one or more copies of a data capsule being lost thereby.

The data are in this case preferably stored in the memory network in the form of what are referred to here as data capsules, with possibly different access codes, this memory network being intended to be a network which is available everywhere in the manner of the Internet, in which possibly a censorship-resistant Extranet, like that known as the “freenet”, can be formed for storing the data. This “freenet” can be made available to everyone on the Internet by certified software, this certified software guaranteeing that, outside the functions described, it has no back doors which could allow illegal access to the data.

The mentioned Extranet in the Internet may in this case be designed in such a way that the data capsules are passed on in a self-organized form to different servers and multiply stored in an identical form, so that traces possibly occurring in the process disappear and cannot be retraced. In addition, this multiple storage—in which the patient can determine the number of identical backup copies by parameterizing a counter—has the advantage that the chance failure of a memory which contains one of the data capsules made anonymous of the electronic health file does not lead to loss of these data, since—even after multiple distribution in the memory network—the majority of the backup copies cannot be stored on the same server.

Irrespective of the fact that such a data capsule can in any case be read only with the aid of the access code, which can be set up with any degree of complexity and is only in the possession of the patient, and which he makes available to third parties, such as doctors, service providers, health insurance companies or the like, only in exceptional cases and, furthermore, possibly also only to a restricted extent, it is still possible for additional security to provide that the data are stored in an encrypted form, an asymmetrical key preferably being used for the encryption of a capsule, with a public patient's key for encryption of the patient file and a private patient's key for decryption, the private key or the pair of keys representing a further component part of the personal authorization information, that is of the personal access code for reading the content of a data capsule.

According to a further feature of the present invention, it may be provided that the contents of the data capsules can be read to a restricted extent by correspondingly authorized third parties, for example doctors, service providers, pharmaceutical companies, health insurance companies or the like, by means of special sub-access codes, preferably providing for this purpose access devices which make it possible for certain parts of the data as statistical data to be extracted, added to, combined and schematized.

Having been made anonymous, the statistical data are in this case—at the instigation of the patient—to be entered and stored in special statistical capsules, which are provided with a globally applicable capsule address, for further use, in particular for retrieval by pharmaceutical companies or health insurance companies, which in return allow the authorizing patient to benefit from certain advantages or payments. Consequently, there is no need to release the actual access code to all the data of the patient's personal health file to allow these statistical functions also to be performed.

According to a further feature of the present invention, the access code or codes may in this case be implemented in special, preferably portable, access devices, such as for example a chip card, a cell phone, a watch, an amulet or the like, but they can also be entered into a public access entity, that is for example a network portal or the like. The access device may in this case be protected in a way known per se by an authentication system, such as for example by a PIN number, to prevent misuse if the access device is lost.

To avoid complete loss of data in the event of a capsule address being lost, in a further refinement of the invention it may also be provided that at least parts of the patient files are stored, possibly even only in a form that is partly readable for the latter, in storage facilities at the premises of the doctors, service providers or the like which are accessible to the patient in order to permit reconstruction of a new data capsule from these copies in the event of loss of a capsule address.

The important health information, which in a sabotage-proof and censorship-resistant personal electronic health file according to the invention is stored securely and yet retrievably for a wide variety of health applications, comprises on the one hand long-term information, to be kept confidential in the interests of the patient, that is all those historical to present-day data as well as speculations and suggestions considered meaningful for any future advice or treatment. This includes case histories, findings, final reports and records of medical studies, such as photos, diagnostic images, videos and audio documents. Hypotheses, interim steps, mistaken approaches, negative findings and so on are to be noted only in respect of the result and according to their probable future significance, but not in all details. In this case, some of these data may be locally provided directly on the personal access device in addition to the personal authorization information (for example emergency data) and/or formed as a pointer, that is to say as a special address by which it is possible to access these data without barriers directly via the network which is available everywhere, with the aid of which the health file according to the invention is realized—at the current time this would be specifically what is known as the Internet.

On the other hand, it is short-term confidential data, such as treatment data, prescriptions, measured values, observations, suggestions etc., which after some time have been evaluated or dealt with and are erased. The data resulting from this are added at appropriate intervals to the long-term data held. For short-term and long-term data, different capsules with different hash addresses may be used here—as already proposed further above—, it being possible to reach both hash addresses with the aid of one and the same individual access device or else with different access devices that are separate from each other. Selection is made in the former case by means of operating software or by means of a configuration capability on the individual access device.

To sum up, it can consequently be stated that the electronic health file according to the invention is characterized by data structures, so that the data can be read only to the extent to which the user can demonstrate to the patient rights in this respect. The patient can himself also read all the parts of the files, provided that he forgoes psychological protection from data of an alarming nature, and also has areas in which he can write, that is change data. The known professional card likewise only allows doctors access to certain parts. On account of double (multiple) encryption, parts remain unreadable to him however (role concept, as it is known). The patient may also define a number of capsules and decide to which he grants access to whom. The role concept can be realized by means of keys or other access restrictions.

Further advantages, features and details of the invention emerge from the further description of several exemplary embodiments and with reference to the drawing, in which:

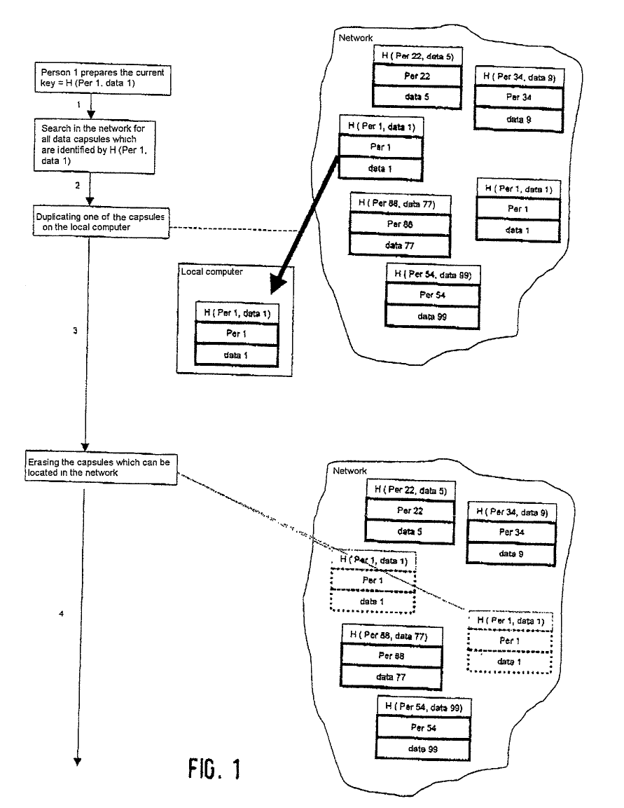

FIG. 1 shows a schematic sequence diagram of the access of an authorized person to data capsules stored in the freenet and the erasure of the old data capsules in the freenet,

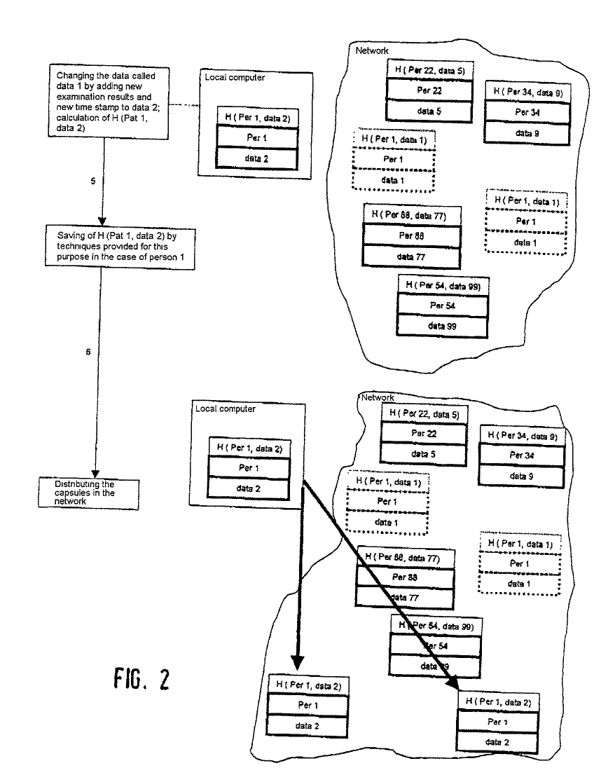

FIG. 2 shows the changing of the data of the data capsule arranged on the local computer and the changing of the access code and the renewed storage with the changed access code in the network,

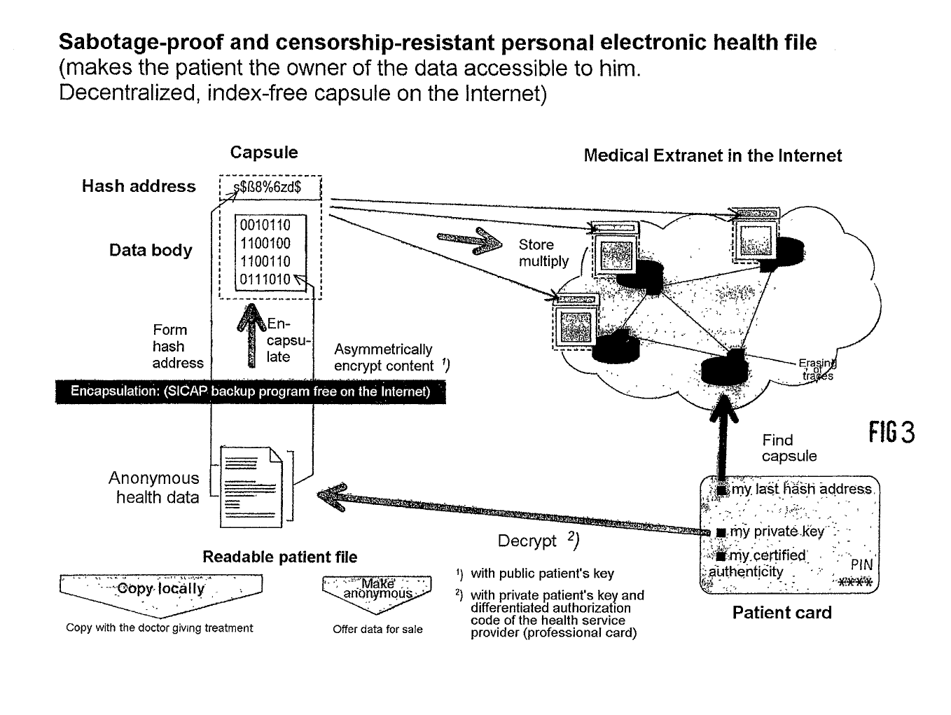

FIG. 3 shows a schematic representation of the organization of a protected personal health file according to the invention on the Internet,

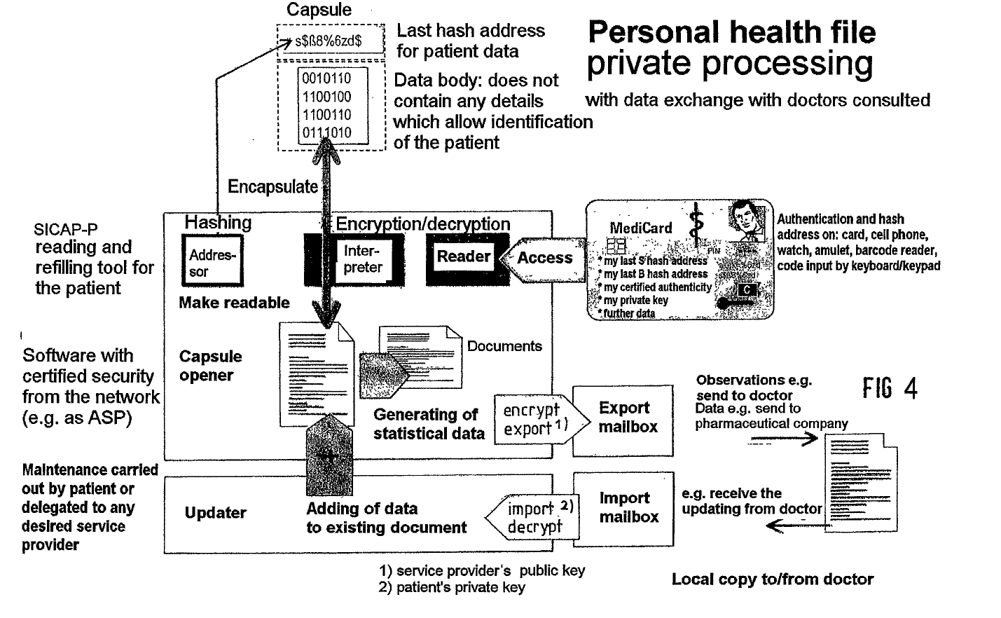

FIG. 4 shows a representation of the personal health file for private processing by the patient,

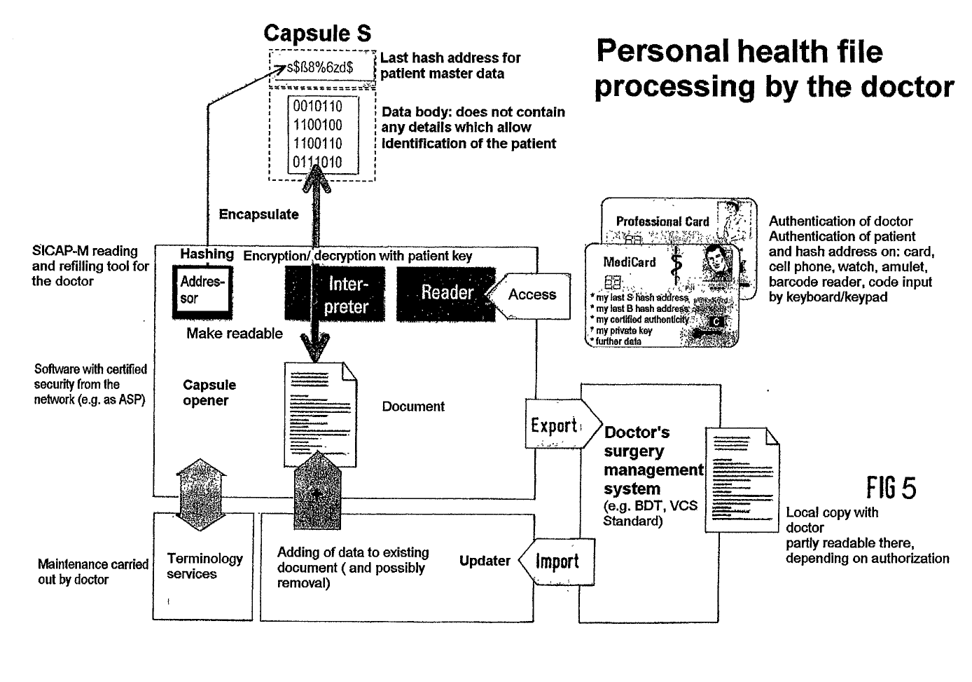

FIG. 5 shows a representation corresponding to FIG. 4 of the possibilities for processing the personal health file by the doctor,

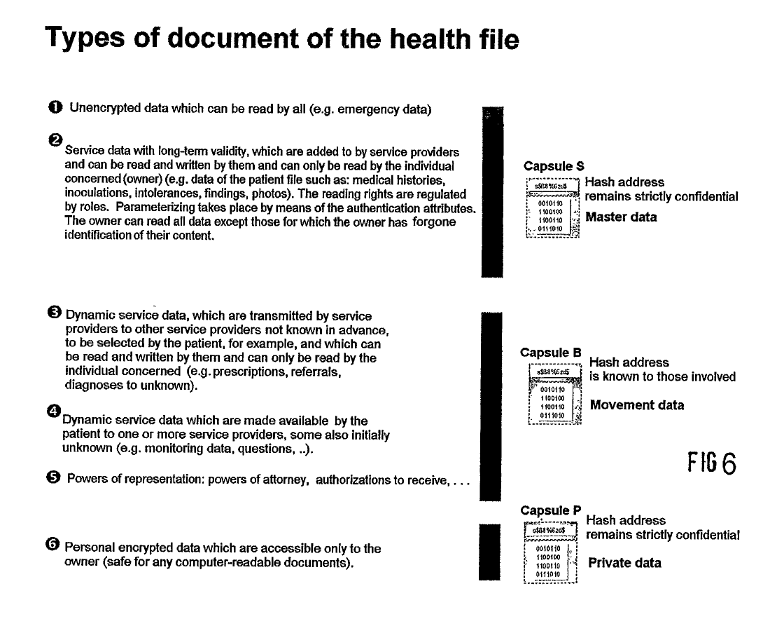

FIG. 6 shows a representation of the types of document of the health file with an example of how the information is divided among different capsules with different hash addresses,

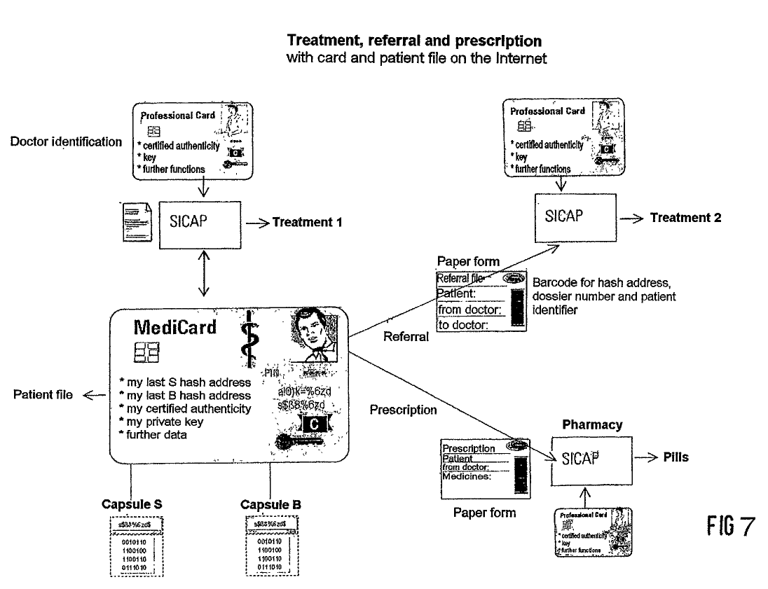

FIG. 7 shows the procedure followed for treatment, referral and issuing a prescription, with a card and patient file on the Internet, using a protected health file according to the invention, and

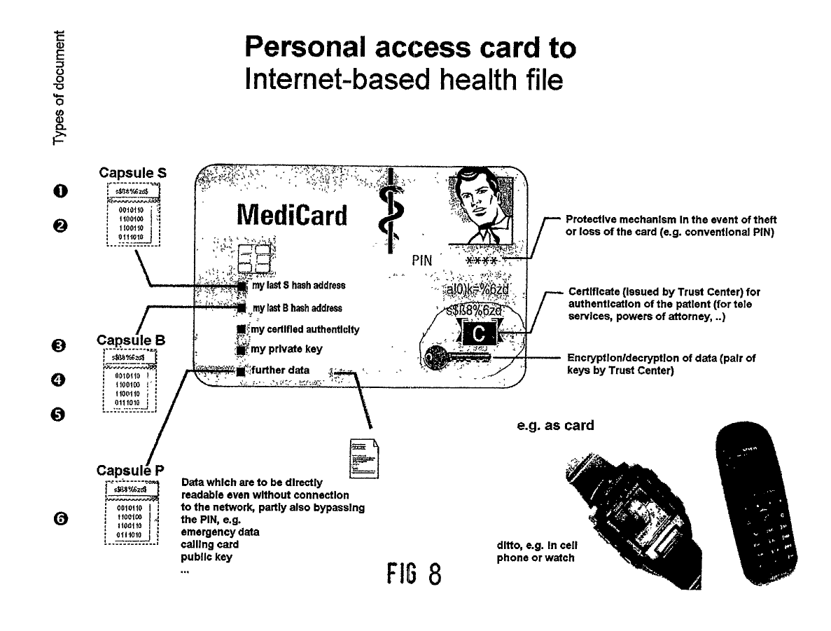

FIG. 8 shows the layout and organization of a personal access card for the Internet-based health file according to the invention.

In FIG. 1, it is shown on the basis of a schematic sequence diagram how initially a person 1 prepares a current access code, a key H, which is formed from personal data and memory data, called data 1. With this key, it is possible to search for all data capsules which are stored with the corresponding key in the network. If such a data capsule is found—a data capsule is understood as meaning a multiplicity of patient data protected by a common access code in a special data structure corresponding to the requirements of the respective memory network—a copy of this data capsule is made on the local computer and, if there is a change authorization, which is part of the current key and is to be contained on the latter in a non-readable form, all the corresponding data capsules which can be found in the network are erased. This erasure of the data capsules is represented at the bottom right in FIG. 1 by the dash-dotted lines of the two existing data capsule copies in the network. FIG. 2 shows how, by changing the data called data 1 by adding new examination results or a new time stamp, a change to data 2, and consequently a change of the access code, is automatically accomplished. With this changed access code, the now changed data capsule arranged on the local computer is stored again by the customary techniques and distributed in the network. This can be seen at the bottom right in FIG. 2, where two changed data capsules have now been stored with the access code H (Per 1, data 2), while the old data capsules are erased in the same way as before with the access code H (Per 1, data 1).

FIG. 1 schematically shows the layout of a sabotage-proof and censorship-resistant personal health file, which makes the patient the owner of the data accessible to him, the health file comprising one or more decentralized index-free capsules on the Internet. Represented in FIGS. 4 and 5 are the various possibilities for storing into and reading out from the health file stored on the Internet, on the one hand for the patient himself and on the other hand for the doctor as an exemplary embodiment of an authorized user, the authentication and the hash address, which in principle may be arranged on different types of access devices, such as for example a cell phone, a watch, an amulet, an electronic tag in the form of a transponder, a barcode reader or by keyboard/keypad code input, being realized in the exemplary embodiment shown by means of a chip card, which is represented in its layout and in its data organization and also a little more precisely. According to FIG. 5, the personal health file can be used by the doctor as follows:

The patient, who is present in person, leaves with the doctor a physical personal patient card, the doctor finds a capsule(s) on the Internet and opens it (them) with the patient card (and doctor card). He enters the fact that treatment has been given and the date and time of the treatment, makes a local copy and re-encapsulates with a new last hash address (for example known or unknown to him) and sends the new capsule back into the Internet. If the hash address has changed in the process, all the old capsules are erased by the execution of program parts to be correspondingly provided. From now until an important interim completion, the doctor works on his local copy and uses this for referrals and tele services. The patient can prove his identity in the network by authentication. Updating the results of treatment on the patient card must take place separately. In the case of an asymmetrical key, it is also possible without the patient card, as long as the valid hash address is known to him and is not changed.

In FIG. 6, the various types of document of the health file are indicated according to the manner in which they are established and their significance for the health file, and also with regard to the varying levels of encryption possibilities and varying access possibilities. Specifically the patient data stored in what is known as capsule B—here, too, it could of course again be a number of different data capsules—, which are less in need of confidentiality and which also include, for example, what are known as statistical data, can be retrieved at any time by corresponding service providers (in return for corresponding payment to the patient).

The procedure followed for treatment, referral or issuing a prescription with the aid of chip cards as access cards to the electronic personal health file on the Internet are schematically indicated in FIG. 7 as a diagram, while—as already mentioned—FIG. 8 explains in more detail a chip card as a personal access card of the patient to his electronically stored health file on the basis of the various graphically indicated access possibilities.

To use the personal health file for tele medicine, the doctor works for example with the data from his local copy and with the technology preferred by him, and uses this for the tele services. The patient can prove his identity in the network by means of his authentication and consequently take part in tele services with authorization.

The personal patient file may have further areas into which data can be written and from which data can be read, these areas being omitted from the hash formation, so that data entries in these areas do not lead to changing of the hash address. These areas may also be used for private health management, so that measured values from instruments and data from labels on medicines and remedies and aids can be entered here.

1. A protected electronic health file for managing all the health-relevant data, including earlier diagnoses and treatments, of a patient in the form of data capsules on a number of decentralized servers of a network with an access code which can be released by the patient, characterized in that, when there is a change or addition to a called-up data capsule, the old data capsules in the network are erased and a new access code is formed, under which the changed data capsule is re-stored again in the network.

2. The health file as claimed in claim 1, characterized in that the access code is formed from personal data and memory data in the manner of a hash key.

3. The health file as claimed in claim 1 or 2, characterized in that the access code contains a specially protected change authorization, by means of which the automatic erasure of the old data capsules is brought about.

4. The health file as claimed in one of claims 1 to 3, characterized in that the data capsules are stored in a censorship-resistant Extranet (“freenet”).

5. The health file as claimed in claim 4, characterized in that the Extranet is designed in such a way that the data capsules are passed on in a self-organized form to different servers and multiply stored in an identical form, so that traces possibly occurring in the process disappear and cannot be retraced.

6. The health file as claimed in claim 5, characterized in that the patient can determine the number of identical backup copies by parameterizing a counter.

7. The health file as claimed in one of claims 1 to 6, characterized in that the data are stored in an encrypted form.

8. The health file as claimed in claim 7, characterized by the use of asymmetrical keys.

9. The health file as claimed in claim 8, characterized in that the private key or the pair of keys is a component part of the personal authorization information for reading the content on the personal part of a stored data capsule.

10. The health file as claimed in one of claims 1 to 9, characterized in that the contents of the data capsules can be read to a restricted extent by correspondingly authorized third parties, for example doctors, service providers, pharmaceutical companies or the like, by means of special sub-access codes.

11. The health file as claimed in claim 10, characterized in that access devices which make it possible for certain parts of the data as statistical data to be extracted, added to, combined and schematized are provided.

12. The health file as claimed in claim 11, characterized in that, having been made anonymous, the statistical data are entered and stored in a special statistical capsule, which is provided with a globally applicable capsule address.

13. The health file as claimed in one of claims 1 to 12, characterized in that the access codes are implemented in special, preferably portable, access devices (such as for example a card, a cell phone, a watch, an amulet or the like), which for their part are protected by an authentication system.

14. The health card as claimed in one of claims 1 to 13, characterized in that at least parts of the patient files are stored in storage facilities at the premises of doctors, service providers or the like which are accessible to the patient (and permit reconstruction of a new data capsule from these copies in the event of loss of a capsule address).
